(19) United States
(12) Patent Application Publication
(10) Pub. No.: US 2004/0051420 A1
(43) Pub. Date: Mar. 18, 2004

(54) Electromechanical transducer and method for manufacturing an electromechanical transducer

(76) Inventor: Heikki Raisanen, Jyyaskyla (FI)

Correspondence Address: KATTEN MUCHIN ZAVIS ROSENMAN, 575 MADISON AVENUE, NEW YORK, NY, 10022-2585, US

(21) Appl. No.: 10/464,058

(22) Filed: Jun. 18, 2003

Related U.S. Application Data
(63) Continuation of application No. PCT/FI01/01125, filed on Dec. 19, 2001.

(30) Foreign Application Priority Data
Dec. 19, 2000 (FI) 20002780

(51) Int. Cl. H02N 2/00

(52) U.S. Cl. 310/311

(57) ABSTRACT

Electromechanical transducer element for converting mechanical stress into electrical signals, said transducer comprising: at least one transducer elements (119,120), said element having first and second surfaces; at least one signal electrode layer (209) arranged between two transducer elements, said signal electrode layer being a metal layer arranged in direct contact with first surfaces of the two transducer film elements. Bosses may be arranged adjacent to and/or partly onto at least one electrode layer. The invention relates also to a manufacturing method where adjacent to and/or partly onto a signal electrode and/or a ground electrode a thicker layer of isolating material is deposited, or for composition of the film bosses are arranged in the signal and/or ground electrode.

### FIELD OF INVENTION

The present invention relates to an electromechanical transducer element for converting mechanical stress into electrical signals and, in particular, to an flexible unitary electret film transducer element, and to a method for its fabrication. These kind of transducers can be used for example as pressure, force, acceleration and vibration transducers.

### PRIOR ART

As for an electromechanical transducer elements, piezoelectric crystals, piezoelectric sheet (e.g. polyvinylidene fluoride PVDF) and voided electret sheet belong to the prior art. In the commonest film type transducer structures, the metal electrodes are screenprinted silverpaste either on the transducer element or on a plastic film laminated together with transducer element, and connecting cable part is implemented using screened coaxial cable, which is connected to the electrode layers by means of crimped connectors. A drawback with this type of structures is the overall mechanicall strength, and difficulties to implement an integrated structure with necessary preamplifier part.

The electret field, or the permanent electric charge, is achieved by injecting charges into dielectric material.

A dielectric voided electret film and manufacturing process for same, applicable for use as electromechanical material for a transducer, is described in U.S. Pat. No. 4,654,546, said dielectric film comprising permanently charged, biaxially oriented, foamed, usually homogenous film layer containing flat lens-like, shredded or cavitated gas bubbles which can also be called voids or cells. The term “dielectric cellular electret film” is used here to refer to generally voided type electromechanical films having a permanent electric charge injected into material. Voided electret films are highly elastic and compress in thickness under pressure. In dielectric cellular electret film, flat lens-like gas bubbles effectively limit the mobility of electret charges in the dielectric material, because the gases have an electric resistance five decades better than the best solid insulating materials have. At the same time, compared to hard structure of piezoelectric materials, they act as an elastic soft layer during the conversion of vibrations into electric signals allowing pressure variations to cause microscopic changes in its thickness. The change in thickness causes change in capacitance and produces an electrical output voltage in proportion to the force.

WO-publication 96/06718 presents a procedure for pressure inflation of a pre-foamed plastic film, that makes it possible to manufacture strongly foamed film products, involving a high foaming degree and allowing the thickness of the product to be increased without increasing the amount of plastic material. The term “dielectric swelled cellular electret film” is used herein to refer to a foamed film-like plastic product as described in that WO-publication and having a permanent electric charge injected into material.

WO 97/39602 presents a stringed musical instrument transducer for converting string vibrations into electric signals, which transducer is composed of electromechanical sheets and is capable of converting string vibrations into electric signals. The electrodes required by the electromechanical sheet are disposed on the surface of one or more thin and flexible dielectric materials, said electrodes forming electrically conductive surfaces of the transducer for connecting the transducer to a signal processing device, and which transducer is constructed of a unitary, thin and flexible layered sheet structure.

In the transducer described in WO 97/39602, the signal electrode is arranged on the insulate sheet. As it is printed, it becomes typically 20 microns above the level of the insulate sheet. Therefore, when the transducer is under continuous pressure, which is the case in many applications, the transducer element compresses more from the signal electrode area than from the area beside the signal electrode.

### SUMMARY OF THE INVENTION

The object of the present invention is to eliminate the drawbacks of prior art and achieve an improved transducer of a completely new type, in which a dielectric swelled cellular electret film is used to transform the mechanical stress into electric signals, and wherein no dielectric firm plastic layer to carry the conductive electrodes will be needed in the transducer structure. Thus the transducer becomes mechanically stronger, thinner and the electrical properties become excellent because the firm plastic layers are not absorbing and dampening the vibration or other mechanical energy. Further, because of saved thickness exclusive firm plastic films, the amount of transducer elements can be increased, without adding too much thickness, and thus the output voltage and therefore the signal-to-noise ratio are further improved. Further, due possible increase in thickness of elastic soft dielectric cellular layers the structure becomes softer. Even further, the electrodes become more durable than screen-printed electrodes and can be easily connected by soldering to the preamplifier or connecting wire instead of using crimped connectors where there are plastic layers in between. Thus the electrical properties of connections become excellent and also more durable. Further, it is possible to simultaneously arrange the screening for the connection and the transducers of the invention are very cost effective to manufacture.

A further object of the invention is to produce a transducer as simple as possible, having no separate transducer part and no separate conductor for connecting it to a signal processing device, but which has a unitary, flexible and laminated structure and in which the connections for connecting it to a preamplifier can be disposed sequentially or side by side and which in itself is able to produce a balanced signal (differential transducer).

The invention relates also to a manufacturing method where adjacent to and/or partly onto a signal electrode and/or a ground electrode is deposited a thicker layer of isolating material, or for compression of the film bosses are arranged in the signal and/or ground electrode whereby the elastic sensor film when the sensor is continuously pressed can during a strong pressure be compressed entirely or at the highest points only. With this construction the sensor generates many times higher voltage under a high pressure than a conventional sensor.

In one embodiment of the invention, an durable and cost effective accelometer type transducer, wherein both the transducer and its preamplifier are arranged on same side of printed circuitry board, is achieved.

The invention is in detail defined in the attached claims.

With the invented manufacturing method, it is possible to produce ultra thin and flexible transducers of desired length, design and width, in which the electrodes in the transducer part are continuous extending from the transducer part to the preamplifier and which are unitary, flexible and thin laminate in construction. Fabrication is faster and more economic than with conventional methods.

The structure of the invention thus allows the application of an effective and economic production technique with significantly improved electrical properties.

### BRIEF DESCRIPTION OF THE DRAWINGS

In the following, the invention is described in more detail by the aid of examples by referring to the attached drawings, in which

FIG. 1a presents an exploded perspective view illustrating the different components that comprise the transducer of the invention without extra dielectric layers carrying the electrodes at the transducer area, with connectors in preamplifier end arranged side by side,

FIG. 1b presents an exploded perspective view illustrating the different components that comprise the transducer of the invention without extra dielectric layers carrying the electrodes at the transducer area, with sequentially arranged connecting areas. in preamplifier end,

FIG. 2 presents the signal electrodes of the transducer of the embodiment in FIG. 1a,

FIG. 3 presents one side ground electrodes of the transducer of the embodiment in FIG. 1a,

FIG. 4 presents an exploded perspective view illustrating the possible screening of the connector end,

FIG. 5 presents a microscope picture of dielectric cellular electret bubble film.

FIG. 6 presents an exploded perspective view illustrating the different components that comprise another type of a transducer according to the invention, and

FIG. 7 presents an exploded perspective view illustrating a net of different components from which the components, that comprise a second type of a transducer according to the invention, are achieved.

### DETAILED DESCRIPTION

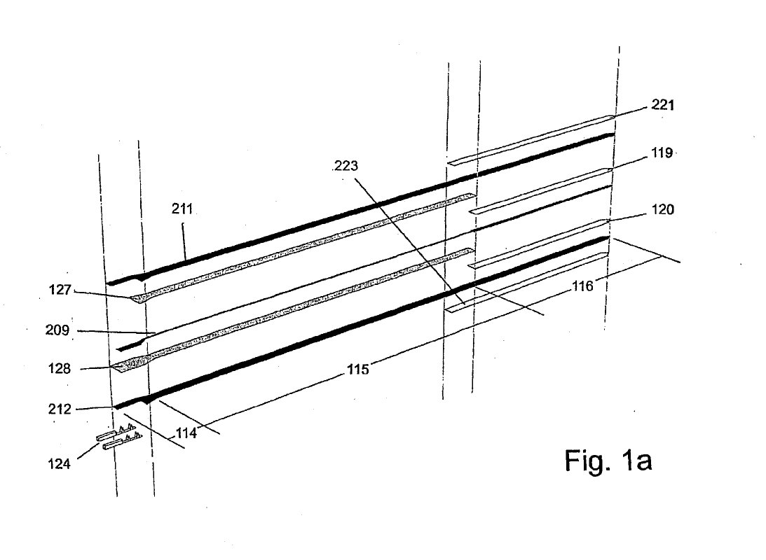

The transducers of invention in FIGS. 1a and 1b consists of a connector part 114 including connectors connecting the transducer to a preamplifier, a connection part 115 corresponding to a connection cable in a conventional transducer and a transducer part 116 for converting the vibrations into electric signals. As may be noted the transducers in FIGS. 1a and 1b have no separate transducer part and no separate conductor for connecting it to a signal processing device, but are of a unitary, flexible and laminated structure extending from the end of transducer part 116 unitary as a connection part 115 up to the connector part 114 and in which the connections for connecting it to a preamplifier can be disposed in sequentially or side by side.

Referring now to FIG. 1a, signal electrode 209 is a thin metal film, for example tinbronze-alloy or tinned copper with thickness of preferably 0.035 up to 0.1 mm. It is to be noted that many thin metal films and thickness are suitable for the application.

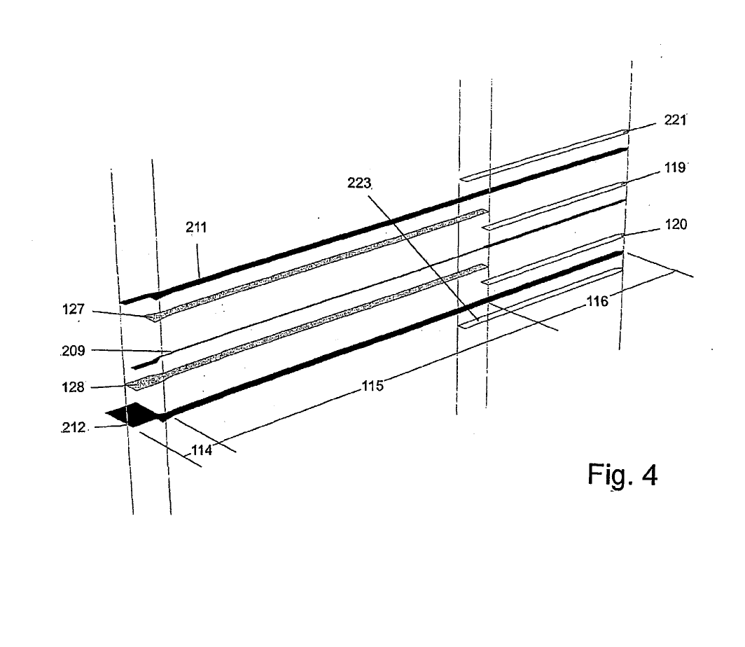

On both sides of the signal electrode 209 there are swelled dielectric cellular electret films 119, 120 having flat gas bubbles 301 (FIG. 5), and on the outer sides of the cellular electret films 119, 120, ground electrodes 211, 212. Signal electrode 209 has a form where the electrode is broad in the transducer part and narrow in the connection part. In the connector part the signal electrode has an area corresponding the connection area of the connector 124. Ground electrodes 211, 212 each comprises of thin metal film. Both the ground electrodes 211, 212 are connected together with a connector 124 in the connector part 114.

Cellular electret films 119, 120 in the transducer area may each comprise of several film layers. Each film 119, 120 is charged. Preferably positive charges are injected onto the underside of sheet 119 and onto the top side of sheet 120. Negative charges may be injected onto the top side of sheet 119 and onto the underside of sheet 120 but it is not essential. The films 127, 128 in the connection part are preferably uncharged operating thus as isolating film layers between the electrodes. It is also possible to extend the cellular electret films 119, 120 all the way to the connector part 114 but preferably use only partially charged film so that there is no charges in the connection part 115, to avoid the connection part become active. The ground electrodes 211, 212 can also be sputtered, evaporated or chemically metallized to the outer sides of the bubble films 119, 120. It is also possible to arrange the signal electrode 209 directly on the face of bubble film 119 or 120 by for example chemical metallizing process or screenprinting. In this embodiment, to increase the output voltage, it is also possible to use two, or even more, signal electrodes 209 by using three or more transducer elements 119-120 and in between each said element having one signal electrode 209 and at the outermost faces of the outermost transducer elements having the ground electrodes 211-212. Further, by using two signal electrodes, two ground electrodes and three transducer elements, and having the two signal electrodes in connection part arranged side-by-side, an differential transducer can be obtained.

The outermost film layers 221, 223 are not essential for the transducers operation but in some embodiments of the invention, they can act as extra elastic layer in between the vibrating members or as insulation layer for example against printed circuitry board.

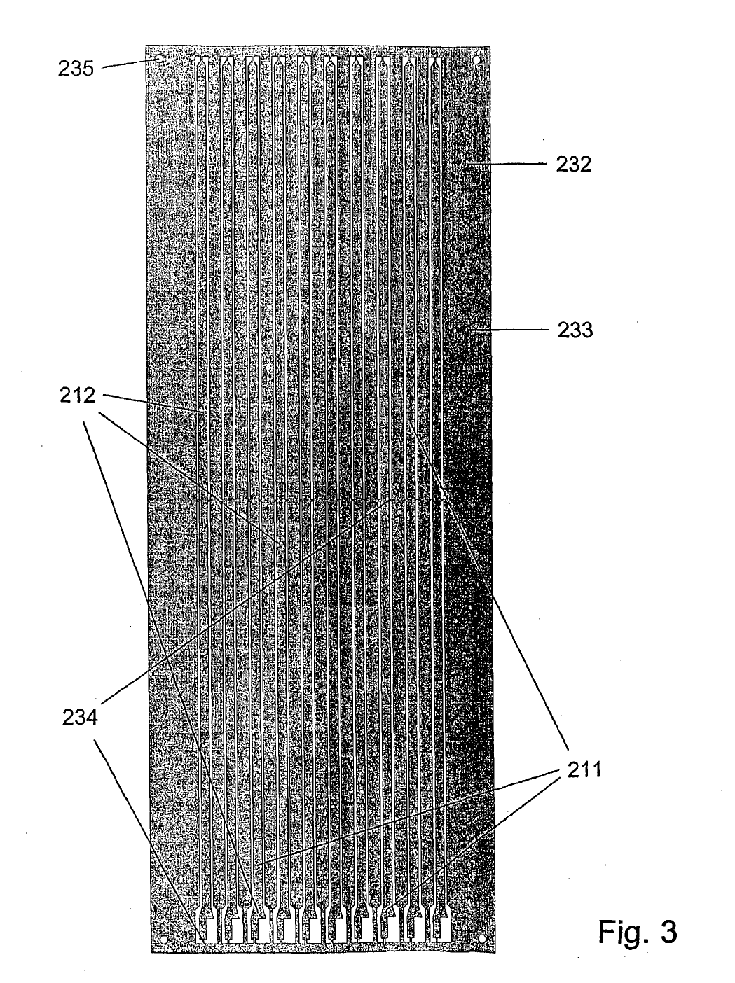

FIG. 4 shows how the ground electrode 211 may have an extension 224 on the side to form shielding against electrical interference in the connector end 114. Because the connector area in the signal electrode is open for electromagnetic interference, it must be shielded. Typically this is taken care by metal housing of the preamplifier circuitry, but by this way, an very small preamplifier circuitry can be integrated into the connector end. The components of the circuitry, preferably one field-effect (FET) transistor and one resistor, are connected to the transducers electrodes 209, 211, 212 and the screening extension 224 is folded around the connector end 114 by using double sided tape 226, which also forms the necessary insulating in between the components and extension 224. Leads are connected to the circuitry for taking the signals to the amplifier. By having the preamplifier circuitry as close as possible to the transducer unit, the capacitance of the connection part is. lowest possible and the signal-to-noise ratio becomes significantly better.

The transducers in FIGS. 1a and 1b and 4 are fabricated as follows:

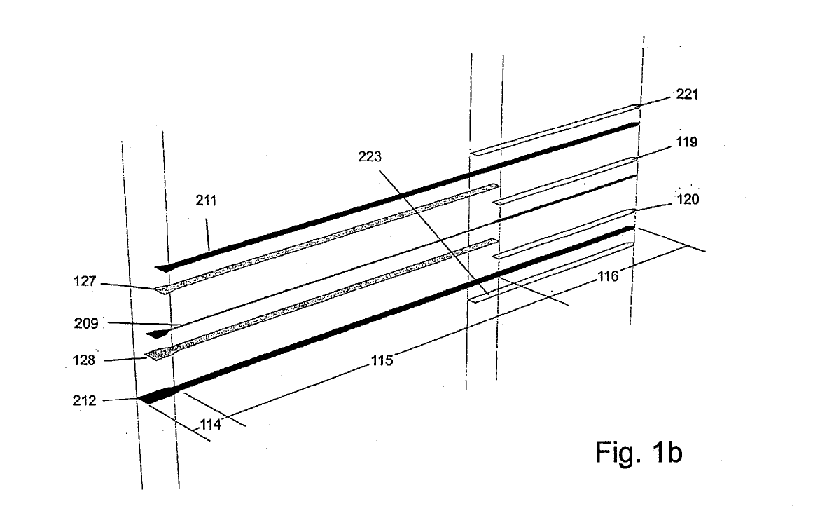

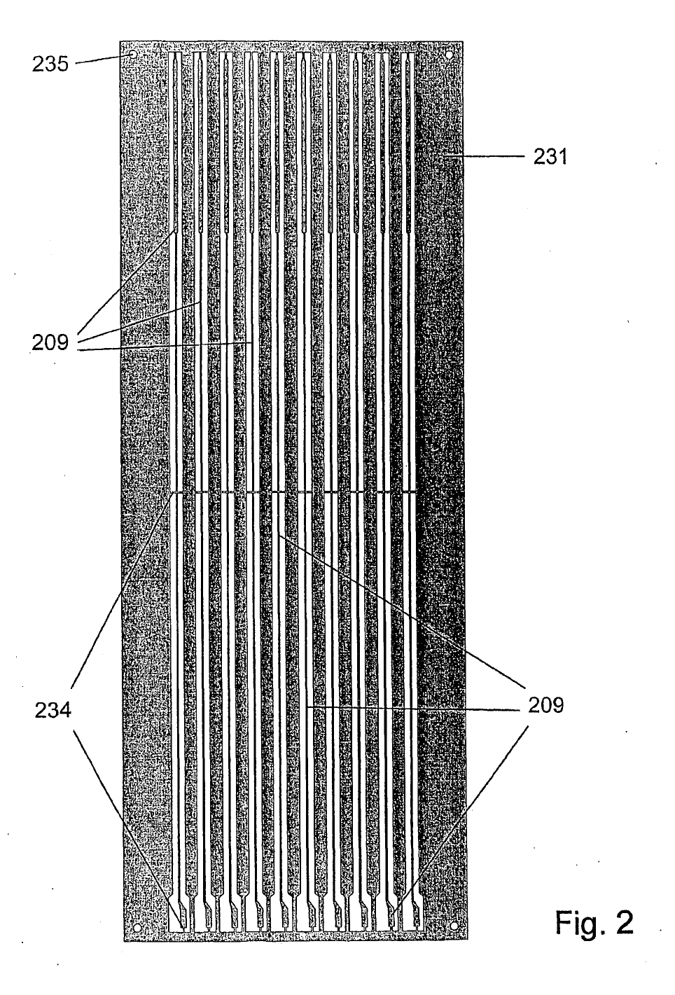

Referring to FIG. 2 signal electrodes 209 and ground electrodes 211, 212 are made of a thin metal film 231, 232, 233. Firstly the thin metal film 231, 232, 233 is screenprinted both sides with an insulating material in the areas to form the electrodes. Secondly the metal films 231, 232, 233 are taken into chemical corrode process where all metal except the areas coated with insulating material, is corroded away. Thirdly, the metal film is taken into next chemical process, where the insulating material is removed for example with alkaline solution. After this, a metal film 231, 232, 233, where the wanted electrodes are connected to each others and frame surrounding them with very narrow keepers 234, is remained. In the corners of each metal film 231, 232, 233 there is a hole 235 to ease the assembly. It is to be noted that there is other ways too to make similar metal film 231, 232, 233 containing electrodes for several transducers and with keepers connected to each others and frame. One way is to laser cut the same pattern from a metal film, other way is die-cutting the metal film with suitable tool having the same pattern. Water cutting can also be used.

Cellular electret film elements 119, 120 size large enough, consisting typically a laminate of 1-3 dielectric cellular electret films, preferably swelled, and metal films 231, 232, 233 are glued together so that first against metal film 232 with ground electrodes, transducer element 119 and insulating layer 127 are glued, and next, on the other side of the transducer element 119 and insulating layer 127, the metal film 231 with signal electrodes is glued, and next, to the other side of metal film 231, second transducer element 120 and second insulating layer 128 are glued, and next, on the other sides of the transducer element 120 and insulating substrate 128, metal film 233 with second ground layers is glued. In this way a laminate is obtained from which the transducers can be cut away by for example by die-cutting, laser cuffing or water cutting. Further the connectors 124 can be connected by pressing them to connector end 114.

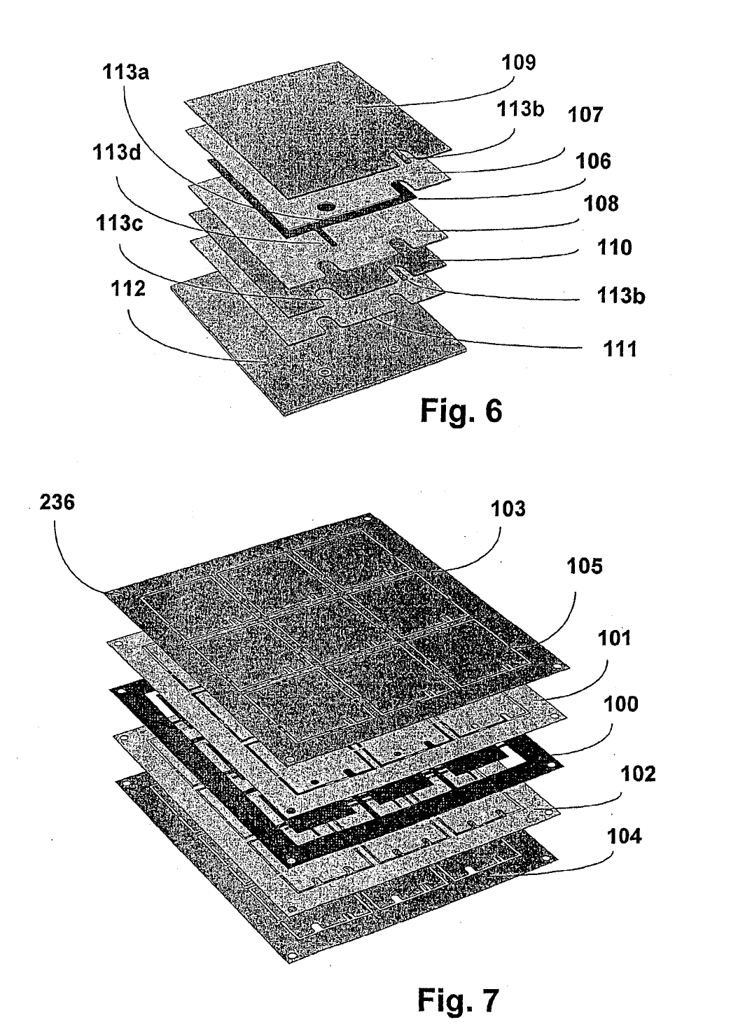

It is also possible first to lay a sheet of glue on both sides on a sheet of dielectric cellular film. Such thin, typically 50 microns thick, glue sheets are manufactured for example by 3M. Obtained sheet of dielectric cellular film 101 (FIG. 7) with glue covered by silicon papers is further diecut to form a suitable pattern with metal electrodes 100, 103, 104 including holes 236. This sheet is further first glued, for example against the net of ground electrodes 103 by removing the silicone paper from the areas to come against ground electrode and holes 236 in align. All extra material is removed after glueing.

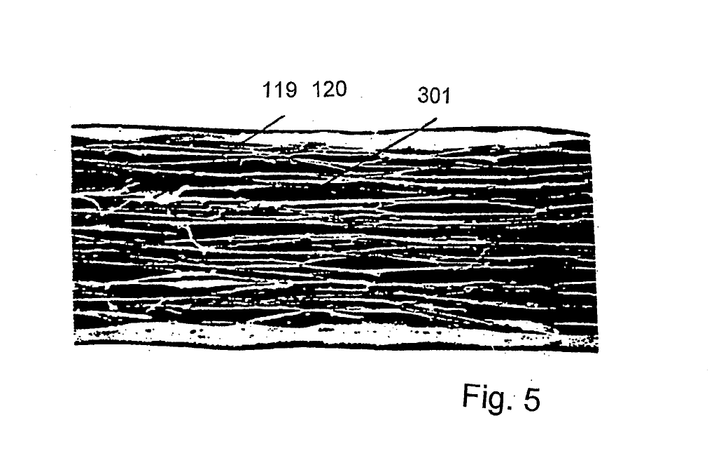

Next, the silicone paper on the other side of the electret film is removed and the net 100 forming the signal electrodes is installed against metal net 100 with holes 236 in align. Further another sheet of electret film 102, with glue sheets on both sides covered with silicone paper, and diecut to suitable form, is glued against the the net of signal electrodes 100 by first removing the silicone paper from the areas to come against the signal electrodes. The last is to attach the second net 104 of ground electrodes against it. Further it is possible for attaching the sensor to PCB board, have a suitable glue sheet first diecut to form a suitable pattern and attached it to this of transducers, as can be seen in FIG. 6. By this way, a sheet containing several transducers side by side is obtained, from which separate transducers can easily be removed because the net is hold together by only tiny keepers 105, which are easily cut when pressed. Transducers are very well screened, cheap to manufacture, reliable to connect to preamplifier,. and good in perform.

The sensors have very good output because two electret film sheets 107, 108 are connected in parallel to signal electrode, as referred in FIG. 6. Further the pattern can be made such that signal electrode 106 has edges 113a arranged wholly inside the sensor structure in order to get a disturbance-free signal output, and the ground electrodes 109, 110 have small extensions 113b, and other ground electrode 110 has opening 113c for an extension 113d at the signal electrode 106. The extensions 113b, 113d can be bent 90 degrees and soldered directly to holes in a PCB board 112 after the sensor is first glued against it. Because the outer ground electrode 110 is arranged with a pattern where there is no hole for extension 113d at the signal electrode 106, it becomes completely shielded against electromagnetic interference from that side. The PCB can have the necessary components for preamplifier and there may be an isolating layer 111 between the PCB 112 and ground electrode 110. PCB can be same size as sensor and have the components on the other side or it can be larger and components can be on the same side as the transducer. If the transducer is on the same side as components, it can have a suitable mass added over it to work as accelometer type transducer. If the components are on the opposite side to the transducer, the PCB itself can form the mass for the transducer. It is also possible to exclude the ground electrode 110 and have the ground electrode arranged on the printed circuitry board 112 against which the transducer is applied. For a person skilled in art it is also possible to arrange a differential type transducer with this manufacturing technique, by arranging the screening with other ways for example by metal housing over the printed circuitry board.

In the manufacturing method where adjacent to and/or partly onto a signal electrode and/or a ground electrode is deposited a thicker layer of isolating material, or for compression of the film bosses are arranged in the signal and/or ground electrode whereby the elastic sensor film when the sensor film is less compressed on the points against the bare signal electrode than against the isolation layer which partly can overlap the signal electrode, whereby a sensor elements achieved with a corresponding signal electrode film, and wherein the sensor film against the isolation layer in hard pressure compresses less than in other parts. The isolation can be printed also on corresponding points in the ground electrode, or in the ground electrode only. When printed onto electrode, it can be same material as the electrode, ie. for example silver paste. We have noticed in many experiments, that the output voltage remains much higher with this kind arrangement when the transducer is in continuous high pressure or should withstand continuous high pressure impacts. Thus an improved signal gain is achieved, even two or more times better signal gain can be achieved, and the dynamics and linearity are also improved.

This can be achieved with an etching method described above whereby all the electrode surfaces can be made. Etching can also be realised so that when a certain figure is printed with isolating material on the surface of the metal, and the object is held in the process only a certain defined time, only a part of the metal is corroded (and forms a hollow).

There is multiple applications for this type transducers, for example keyboard switches, even force sensitive, electronic stethoscopes, and musical instruments pickups just to name a few; switches, accelometers and vibration sensors in general.

This procedure allows a considerably larger number of thin, flexible transducers of desired length, width and shape and having a continuous structure without joints than by conventional methods to be fabricated by the same amount of work while the manufacturing costs remain low. Further, referred to the Figs 1a and 1b, the transducers can be manufactured very thin without any extra flexible firm insulating substrates to carry the electrodes. Because there is thickness saved due no extra firm insulating substrates, there can be more of active layers, easily 4 layers, which further improves the output voltage and thus also the signal-to-noise ratio.

It is obvious to the person skilled in the art that different embodiments of the invention are not restricted to the examples described above, but that they can be varied within the scope of the claims presented below. The number of films and layers on top of each other can be chosen in accordance with the need in each case and the transducer can also have a shape other than rectangular in top view.

1. Electromechanical transducer element for converting mechanical stress into electrical signals, said transducer comprising:
at least two transducer elements, said elements having first and second surfaces;
at least one signal electrode layer arranged between two transducer elements, said signal electrode layer being a metal layer arranged in direct contact with first surfaces of the two transducer film elements;
at least two ground electrode layers, said ground electrode layers being metal layers arranged in direct contact with second surfaces of the transducer film elements;
said electrodes extending from the transducer part as connection part for connecting the transducer to a signal processing device; and
wherein the transducer part has a unitary laminated structure.

2. Transducer according to claim 1, wherein transducer elements are permanently charged dielectric elastic electret films.

3. Transducer according to claim 1, wherein dielectric elastic electret films are biaxially oriented foamed film layers.

4. Electromechanical transducer element for converting mechanical stress into electrical signals, said transducer comprising:
at least one transducer element, said element having first and second surfaces;
a first electrode layer arranged on first side of transducer element, said signal electrode layer being a metal layer arranged in direct contact with first surface; and
a second electrode layer, said electrode layer being metal layer, arranged in direct contact with second surface of the transducer film element,
wherein at least one electrode layer is formed from one unitary metal sheet with multiple similar electrodes arranged in same sheet and said electrode extending from the transducer part as connection part for connecting the transducer to a printed circuitry board.

5. Transducer according to claim 4, wherein transducer elements are permanently charged dielectric elastic electret films.

6. Transducer according to claim 5, wherein dielectric elastic electret films are biaxially oriented foamed film layers.

7. Electromechanical transducer for converting mechanical stress into electrical signals, the transducer having at least one transducer film element of elastic dielectric cellular electret film, comprising:
at least one signal electrode and at least one ground electrode layer;
characterised in that
one or several bosses are arranged adjacent to and/or partly onto at least one electrode layer; and
the transducer film element, under pressure, is suppressed more on the boss area than elsewhere in the signal/ground electrode area in order to improve the electrical properties.

8. Method for forming an electromechanical transducer element for converting mechanical stress into electrical signals, wherein transducer part has a unitary laminated structure, comprising following steps:
arranging at least one signal electrode layer on first surface of a transducer film element and/or arranging at least one signal electrode layer between first surfaces of two transducer elements, the signal electrode layer being a metal layer arranged in direct contact with transducer elements;
arranging ground electrode layers on second surfaces of said transducer film elements; and
wherein the signal and ground electrodes are first formed from a metal sheet to a net of several electrodes in one.

9. Method for forming a transducer according to claim 8, wherein the transducer elements are charged elastic electret films.

10. Method for forming a transducer according to claim 9, wherein elastic electret films are biaxially oriented foamed film layers comprising essentially flat gas bubbles.

11. Method for forming a transducer according to claim 10, wherein biaxially oriented foamed film layers, comprising essentially flat gas bubbles, are swelled.

12. Method for forming a transducer according to claim 8, wherein one ground electrode has extension part overlapped over the connector part for forming a shield.

13. Method for forming a transducer according to claim 8, wherein the overlapped extension forms the shield for electronic preamplifier circuitry.

14. Method for forming an electromechanical transducer element for converting mechanical stress into electrical signals, comprising following steps:
arranging at least one electrode layer on first surface of a transducer film element;
the electrode layer being a metal layer arranged against with at least one transducer film element; and
wherein first the electrode is formed from a metal sheet into a net of several electrodes in one and has extension for electrically connecting the transducer to printed circuitry board, and
secondly a net of several transducer film elements is formed from a sheet of transducer film by cutting it to preferred shape, and
thirdly at least one said net of electrodes and at least one said net of transducers film elements are glued together, and
fourthly transducers with at least one metal electrode are removed from each others.

15. Method for forming a transducer according to claim 14, wherein the transducer elements are charged elastic electret films.

16. Method for forming a transducer according to claim 14, wherein elastic electret films are biaxially oriented foamed film layers comprising essentially flat gas bubbles.

17. Method for forming a transducer according to claim 14, wherein biaxially oriented foamed film layers, comprising essentially flat gas bubbles, are swelled.

18. Method for forming an electromechanical transducer for converting mechanical stress into electrical signals, the transducer having at least one transducer film element of elastic dielectric cellular electret film, the method comprising following steps:
arranging at least one signal electrode and at least one ground electrod layer on surfaces of a transducer film element;
characterised in that
one or several bosses are arranged adjacent to and/or partly onto at least one electrode layer; and
that when the layers are laminated onto each other the transducer film element, under pressure, is suppressed more on the boss area than elsewhere in the signal/ground electrode area.

19. Method according to claim 18 wherein adjacent to and/or partly onto a signal electrode and/or a ground electrode is deposited a thicker layer of isolating or electrode material, or for compression of the film one or several bosses are arranged in the signal and/or ground electrode whereby the elastic sensor film when the films are pressed together is compressed more on areas against a bare signal electrode that in other areas

20. Method according to claim 18, wherein certain figure is printed with isolating material on the surface of the metal, and the object is held in the process only a certain defined time, so that only a part of the metal is corroded (and forms a hollow).
